(19) United States
(12) Patent Application Publication
(10) Pub. No.: US 2026/0301369 A1
(43) Pub. Date: Oct. 1, 2026

(54) DYNAMIC CUSTOMIZATION FOR OBJECT DETECTION

(71) Applicant: Microsoft Technology Licensing, LLC, Redmond, WA (US)

(72) Inventors: Mordechai KADOSH, Raanana (IL); Tom HIRSHBERG, Haifa (IL); Zvi FIGOV, Modiin (IL); Yonit HOFFMAN, Herzliya (IL)

(73) Assignee: Microsoft Technology Licensing, LLC, Redmond, WA (US)

(21) Appl. No.: 19/094,053

(22) Filed: Mar. 28, 2025

(51) Int. Cl. G06V 10/764; G06T 11/60; G06V 10/74

(52) U.S. Cl. CPC G06V 10/764; G06T 11/60; G06V 10/761

(57) ABSTRACT

Systems and methods for dynamic customization for object detection. An object detector uses an object detection model (e.g., an open vocabulary model) to detect and classify objects. The object detector supports customization of classifications without requiring the model to be retrained. Embeddings are used to differentiate between various states of detections, enhancing accuracy and relevance of the detection process. In examples, the object detector handles logical conditions by creating a classifier trained to differentiate between various combinations of objects. Aspects of the present disclosure support the use of images for customization, allowing users to provide examples from which the object detector described herein can learn. In further examples, capabilities of the object detector extend to processing live video streams, where users can mark examples in real-time. In some examples, the object detector leverages a generative model (e.g., to provide state contrasts), allowing the system to be adaptable to complex conditions.

### BACKGROUND

Open vocabulary models are machine learning models that are trained to recognize and classify objects in images. A current approach to training a specific open vocabulary model is to train the model to recognize and classify objects for a specific class. In some examples, a change made to the model (e.g., adding an additional object class to detect) necessitates retraining of the model.

It is with respect to these and other considerations that examples have been made. In addition, although relatively specific problems have been discussed, it should be understood that the examples should not be limited to solving the specific problems identified in the background.

### SUMMARY

The technology described herein describes systems and methods to provide dynamic customization for object detection and classification. Aspects of the present disclosure offer a dynamic and efficient approach to object detection and customization, improving the user experience and operational efficiency. For instance, the object detector described herein supports customization of object detection that can be adjusted on the fly, enabling real-time updates and modifications without the need to retrain an object detection model (e.g., an open vocabulary model) or reprocess images. In some examples, text and image embeddings are used to differentiate between various states of detected objects, enhancing the accuracy and relevance of the detection process. In further examples, the object detector handles logical conditions (e.g., AND, OR) by creating a classifier trained to differentiate between various combinations of objects. Aspects of the present disclosure support the use of images for customization, allowing users to provide examples from which the object detector described herein can learn. In yet further examples, capabilities of the object detector extend to processing live video streams, for instance, where users can mark examples in real-time. In some examples, the object detector leverages a language model (e.g., to provide state contrasts), allowing the system to be adaptable to complex conditions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a diagram of a system in which an object detector is implemented for providing dynamic customization for object detection according to an example;

FIG. 2 is a diagram of a system in which an object detector is implemented for providing dynamic customization for object detection according to another example;

FIG. 3 is a diagram of a system in which an object detector is implemented for providing dynamic customization for object detection according to another example;

FIG. 4 is a diagram of a system in which an object detector is implemented for providing dynamic customization for object detection according to another example;

FIG. 5 is a diagram of a system in which an object detector is implemented for providing dynamic customization for object detection according to another example;

FIG. 6 is a diagram of a system in which an object detector is implemented for providing dynamic customization for object detection according to another example;

FIG. 7 depicts a flow chart of a method for providing dynamic customization for object detection according to an example;

FIG. 8 depicts a flow chart of a method for providing dynamic customization for object detection according to another example;

FIG. 9 depicts a flow chart of a method for providing dynamic customization for object detection according to another example;

FIG. 10 depicts a flow chart of a method for providing dynamic customization for object detection according to another example;

FIG. 11 depicts a flow chart of a method for providing dynamic customization for object detection according to another example;

FIG. 12 depicts a flow chart of a method for providing dynamic customization for object detection according to another example; and

FIG. 13 is a block diagram illustrating example physical components of a computing device with which examples of the disclosure may be practiced.

### DETAILED DESCRIPTION

Object detection is used to identify and locate objects within video frames or images. Typically, object detection requires training a model to recognize and classify specific objects or categories based on labeled training data. For instance, a model can be trained to detect instances of tables within a video or image data by providing labeled examples of tables in different contexts. One example of a model for object detection is an open vocabulary model. An open vocabulary model is a machine learning model capable of detecting and classifying objects beyond a fixed set of predefined categories. For instance, open vocabulary models may leverage external sources, such as text descriptions or embeddings from generative models.

In operation, training a model for a specific class/object comprises providing a dataset of labeled images or video frames as input to the model, allowing the model to learn patterns, features, and relationships associated with the target object(s) through machine learning modelling techniques. When a user desires to update the model (e.g., to add a class or object to the model), the model may need to be retrained by reprocessing a training dataset from the beginning, including previous and new training data. For example, if a user desires for the model to detect a specific state of a table (e.g., a dirty table or a clean table) or an additional class or object (e.g., detect chairs in addition to tables), the model has to be retrained on a comprehensive dataset that includes both the original images used for table detection and new images that represent the additional object classes or states. Retraining the model consumes extra compute processing resources, in addition to being time-consuming and inefficient. Additionally, reprocessing images using the retrained model consumes extra compute processing resources, particularly when there are multiple images to reprocess (e.g., frames of video).

The present disclosure resolves the above-discussed problems with updating/retraining models. Implementations of the present disclosure use an object detector including or in communication with one or a combination of object detection models to provide dynamic customization for object detection according to examples. This dynamic customization enables models to be updated at the time of detection (e.g., in real-time or near real-time) without requiring a retraining process on the original dataset and without requiring video/images to be reprocessed by the model. In examples, an object detector receives, as input, an indication of an object of interest to detect in an image. The indication of the object of interest may be received via various modalities and may identify a target object, a class of the object, and/or features of the target object that may be detected. In examples, the features of the target object represent a particular state of the target object. For instance, the object of interest may be a “dirty table,” where the “table” is the target object and “dirty” is the particular state of the target object.

Prior to implementing aspects of the object detector described herein, previous object detection methods may return detections that represent both the particular state of the target object and other states of the target object. For instance, previous object detection methods may return detections that include both dirty and clean tables, as both dirty and clean tables may be closer to an object class of the target object than other objects (e.g., chairs, food, or people) detected in the image. The object detector described herein is operative to differentiate between various states of an object detected in an image (e.g., a clean table versus a dirty table). Thus, the accuracy and relevance of object detection is enhanced.

In further examples, the object detector handles logical conditions (e.g., AND, OR) by creating a classifier trained to differentiate between various combinations of objects. For instance, the object of interest may have a state defined by a logical condition (e.g., a statement that can be classified as true or false to determine the state of an object). For example, “a dirty table with a bottle” is a logical condition that is determined as true if the object (e.g., a table) is detected and a logical state corresponding to the object of interest (e.g., both dirty and has a bottle)) is determined to be satisfied. Logical states are the possible outcomes that the object can have based on the logical condition. For instance, logical states not corresponding to the object of interest are associated with the object of interest with a contrast state (e.g., a clean table with or without a bottle or a dirty table without a bottle). Accordingly, the logical condition is determined as false if the object (e.g., a table) is not detected or if the object is detected and the logical state corresponding to the object of interest (e.g., is both dirty and has a bottle)) is determined not to be satisfied.

In examples, the object detector receives example images representing each logical state associated with the logical condition of the object of interest. Thus, all logical states of the logical condition of the object of interest are individually and collectively represented in the example images. In further examples, the object detector leverages a generative model (e.g., to provide state contrasts), allowing the system to be adaptable to complex conditions.

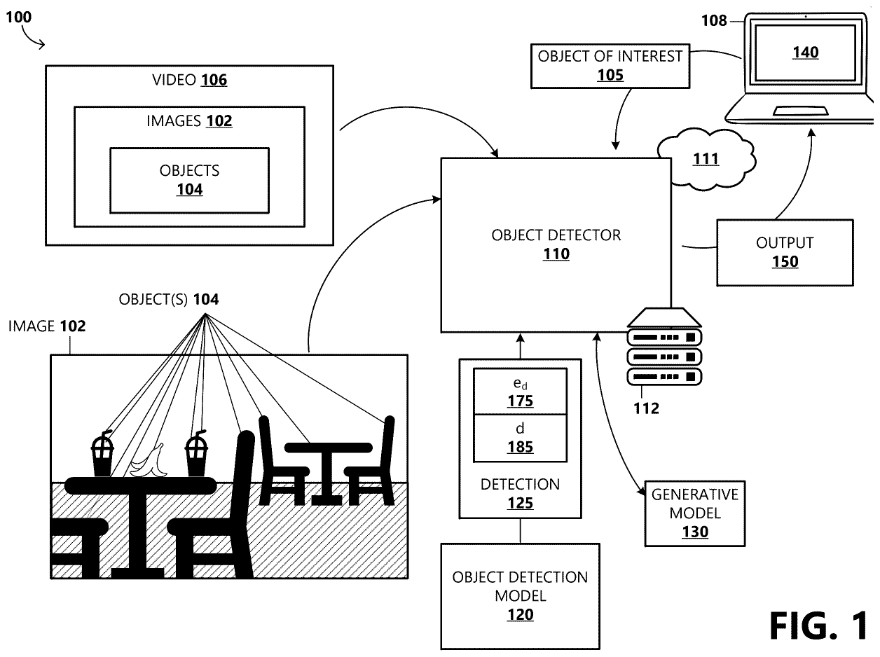

In some implementations, the object detector uses an object detection model to determine an embedding for each logical state and then trains a classifier to differentiate between the logical states based on the logical state example embeddings. Thus, when a detection is made of an object of a same object class as the object of interest (e.g., a table), the object detector uses the classifier to determine whether the logical condition is true or false. For instance, the classifier determines the logical state that best matches the detection. When the OOI logical state (e.g., both dirty and has a bottle) is determined to be satisfied, the logical condition is determined as true. Further, the detection is determined to be the object of interest. Alternatively, when another of the logical states (e.g., corresponding to a contrast state) is determined to be satisfied, the logical condition is determined as false and, thus, the detection is not the object of interest. In some examples, capabilities of the object detector extend to processing live video streams, where users can mark examples in real-time as an object of interest. These and other examples are described based below with reference to FIGS. 1-6.

According to an aspect, a method is provided, comprising: comprising: receiving a first image; receiving an object of interest having an object class and a state; identifying a detection in the first image based on the object class; generating a first representation of the detection; determining a contrast state to the state; generating a second representation of the object class and the state; generating a third representation of the object class and the contrast state; comparing a first similarity measure between the first representation and the second representation to a second similarity measure between the first representation and the third representation; generating a first classification of the detection based on whether the first similarity measure is less than the second similarity measure or whether the second similarity measure is less than the first similarity measure; and providing an output of the first classification.

According to an aspect, a computer system is provided comprising: a processing system; and memory comprising computer program instructions for performing operations comprising: a processing system; and memory storing instructions that, when executed, cause the system to perform operations comprising: receiving a first image; receiving an object of interest having an object class and a state; identifying a detection in the first image based on the object class; generating a first embedding of the detection; determining a contrast state to the state; generating a second embedding of the object class and the state; generating a third embedding of the object class and the contrast state; comparing a first distance between the first embedding and the second embedding to a second distance between the first embedding and the third embedding; generating a first classification of the detection based on whether the first distance is less than the second distance or whether the second distance is less than the first distance; and providing an output of the first classification.

According to an aspect, a computer readable medium storing instructions is provided that, when executed by a computer, cause the computer to: receive a first image; receive an object of interest having an object class and a state; determining whether the state includes a logical condition; when the state does not include the logical condition: identify a detection in the first image based on the object class; generate a first embedding of the detection; determine a contrast state to the state; generate a second embedding of the object class and the state; generate a third embedding of the object class and the contrast state; compare a first distance between the first embedding and the second embedding to a second distance between the first embedding and the third embedding; and generate a first classification of the detection based on whether the first distance is less than the second distance or whether the second distance is less than the first distance; and provide an output of the first classification; and when the state includes the logical condition: determine a set of logical states based on the logical condition, wherein a first logical state of the set corresponds to the state and one or more second logical states of the set correspond to the contrast state; receive a second image for each logical state in the set, where each second image includes an example of the object class and the logical state; generate, for each logical state, a fourth embedding of each example of the object class and the logical state; compare a third distance between the first embedding and each fourth embedding; generate a second classification of the detection based on the third distance; and provide an output of the second classification.

FIGS. 1-6 illustrate example systems 100, 200, 300, 400, 500, and 600 in which an object detector 110 is included for providing dynamic customization for object detection according to an example implementation. Although the example systems 100, 200, 300, 400, 500, and 600 are depicted as including a particular combination of computing environments, devices, networks, etc., the scale and structure of the systems 100, 200, 300, 400, 500, and 600 may vary and may include additional or fewer components and in different arrangements than those described in FIGS. 1-6. The object detector 110 is a software application, system, or module that operates on a computing device 112, such as a server in a network 111 (e.g., a wide area network (the Internet), a local area network, a cellular data network, and combinations or derivatives thereof), a desktop computer, laptop computer, mobile device, gaming device, or other type of operating environment supporting dynamic customization for object detection according to examples. In examples, object detection includes finding a presence of the object 104 in an image 102 (or a plurality of images 102) and identifying a class of the object 104. In some examples, localizing the object 104 further includes determining a location of the object 104 in the image(s) 102, such as by determining coordinates for the object 104 or drawing a bounding box around the object 104. In examples, coordinates of the object 104 are represented by values that indicate pixel positions in the image(s) 102.

According to examples, the object detector 110 receives, as input, image(s) (i.e., one or a plurality of images) 102. In some examples, the image(s) 102 correspond to frames of a video 106. The image(s) 102 may be stored in an image store or provided by a client computing device (client 108) in communication with the object detector 110. In some examples, the image(s) 102 are provided in real-time or near real-time as the image(s) 102 are captured (e.g., by a camera or plurality of cameras). The client 108 may be operated by a user. For instance, the image 102 is provided to the object detector 110 by the user via the client 108. In examples, the object detector 110 provides a user interface 140 via which the user of the client 108 can interact to provide input and via which output 150 from the object detector 110 is presented to the user. In some implementations, the object detector 110 may run on the client 108 (and, thus, the computing device 112 on which the object detector 110 runs and the client 108 may be the same device).

In further examples, the object detector 110 further receives, as input, an indication of an object of interest 105 indicating a target object 104, a class of the object 104, and/or features of the object 104 to detect in an image 102. In some examples, the object of interest 105 is received as text (e.g., a word, a phrase, a sentence, a statement, a question, and/or a combination thereof) that specifies or describes the object 104 that the user wants the object detector 110 to recognize. As an example, the user may provide a textual input, such as “dirty table” or “can you find all the dirty tables?” to guide the object detector 110 to identify dirty tables in the images 102. In other examples, the object of interest 105 is received in the form of an image that includes an example object representing or otherwise indicating the object 104 that the user wants the object detector 110 to recognize. For instance, at an event, the user may provide an image of a specific type of bag (e.g., a backpack with a patch) or a clothing item with a particular feature or characteristic (e.g., a striped shirt) to guide the object detector 110 to identify backpacks with a patch or striped shirts in images 102.

According to an aspect, the object detector 110 includes or is in communication with one or more object detection models (collectively, object detection model 120). In some implementations, the object of interest 105 is known prior to processing an image 102 for object detection. In such cases, the object detection model 120 may employ a closed vocabulary model or a specific object detection model which is trained on a predefined dataset that explicitly includes the object of interest 105. For instance, the term “closed vocabulary model,” as used herein, refers to an object detection model trained on a set of training data and operative to detect objects 104 in an image 102 of a class or classes (e.g., categories of objects sharing a common characteristic) explicitly included in the set of training data. A closed vocabulary model may be implemented as or using a Faster R-CNN (Region-based Convolutional Neural Network), YOLO (You Only Look Once) algorithm, SSD (Single Shot MultiBox Detector), or Mask R-CNN, and may be trained on datasets such as COCO (Common Objects in Context), Pascal VOC (Visual Object Classes), or ImageNet. These examples of closed vocabulary models utilize supervised learning techniques, where large annotated datasets are used to learn object representations and bounding box predictions. For instance, if the closed vocabulary model is trained on a dataset including images of objects of a particular class, such as various images of fruits, the closed vocabulary model may learn to recognize and classify the different types of fruits included in the training data (e.g., apples, bananas, oranges, or grapes) in new image(s) 102.

In other implementations, the object detection model 120 may employ an open vocabulary model that leverages text embeddings and image embeddings within a shared latent space to detect objects 104 in an image 102 of classes not explicitly included in the set of training data. For example, an open vocabulary model transforms text data and image data into a common representation format, which allows the text data and image data to be compared and combined. For instance, the open vocabulary model uses text embeddings to encode a semantic meaning of words or phrases and image embeddings representing visual data. Thus, the open vocabulary model is operative to align text and image embeddings to associate visual features of objects 104 in images 102 with their corresponding textual descriptions. Further, the open vocabulary model leverages the learned associations between the text and image embeddings to generalize to new classes. For instance, if the open vocabulary model is trained on images of common household pets, such as cats and dogs, the open vocabulary model may also learn to detect other types of pets, such as ferrets or hamsters, by leveraging the semantic meaning of related textual descriptions and visual similarities.

In some examples, the object detection model 120 receives an image 102 as an input, detects objects 104 in the image 102, and provides an output including one or more detections 125 (e.g., the detected objects 104) including an embedding (referred to herein as a detection embedding (e_{d}) 175 of each detection 125 and a description 185 of the detection 125. In examples, the description 185 includes a determined class and location (e.g., coordinates or a bounding box) of the detection 125 in the image 102. In some examples, the description 185 further includes an identifier of the image 102 (e.g., a frame number, an image number, or an image name). In other examples, the object detection model 120 receives an image 102 and an object of interest 105 as inputs, detects objects 104 in the image 102 with features relevant to a determined class of the object of interest 105, and provides an output including one or more detections 125 (e.g., the detected objects 104).

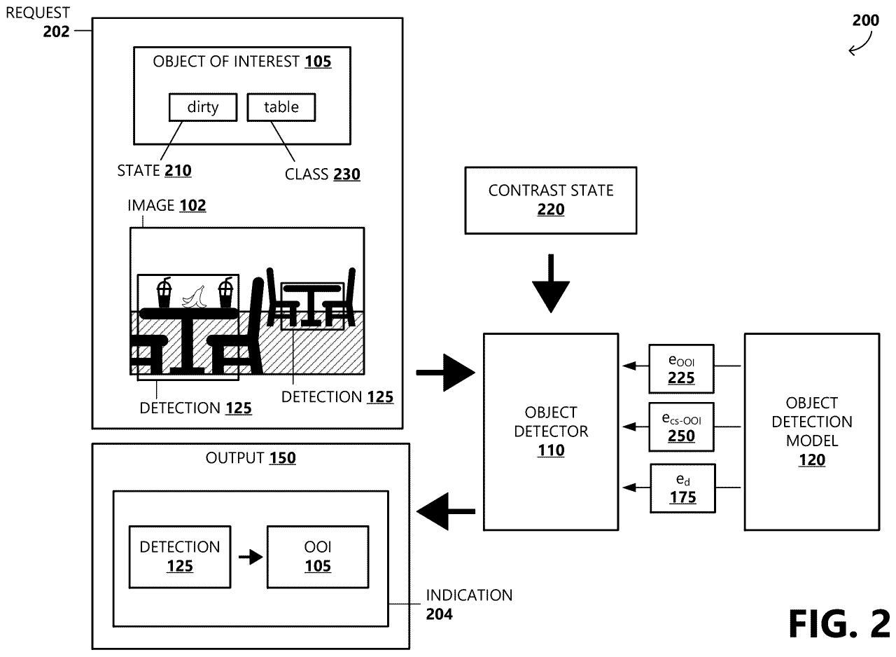

According to an aspect, the object detector 110 leverages output from the object detection model 120 to provide zero-shot learning (ZSL) functionality, where the object detector 110 is enabled to recognize and categorize objects 104 in images 102 without having seen any examples of the objects'classes during training. Thus, when a change is made to the object detection model 120 or a new class (of an object of interest 105) is introduced, the object detector 110 is able to provide dynamic customization to object detection in real time or near-real time. With reference to FIG. 2, the object detector 110 is operative to differentiate between various states 210 of an object 104 (e.g., a clean table versus a dirty table) and, thus, enhance accuracy and relevance of object detection. For instance, without implementing aspects of the disclosure, in response to a request 202 for object detection of an object of interest 105 with a state (e.g., a dirty table) in an image 102, the object detector 110 may return detections 125 that include both dirty and clean tables, as both dirty and clean tables may be closer to an object class 230 of the object of interest 105 than other objects 104 (e.g., chairs, food, or people) detected in the image 102.

In some examples, when an object of interest 105 has a state 210 (e.g., an object 104 and an adjective, phrase, or other indication of a feature or condition of the object 104), the object detector 110 determines a contrast state 220 to the state 210. The contrast state 220 is a feature or condition of the object 104 that differs from (e.g., is in contrast to) the state 210. In some implementations, the object detector 110 provides (e.g., via the user interface 140), an indication to provide the contrast state 220 to the state 210. In response, a user input is received including the contrast state 220, where the contrast state 220 may be provided as text or an image. An image of the contrast state 220 may include an example object representing (or otherwise indicating) the object of interest 105 with the contrast state 220. In some examples, a plurality of contrast states 220 are determined (e.g., received from the user). For instance, the object of interest 105 may have a state (e.g., a striped shirt) with a plurality of contrasts to the state (e.g., a solid shirt, a polka dotted shirt, a plaid shirt, a floral shirt).

In other implementations, the object detector 110 is in communication with a generative model 130. The term “generative model,” as used herein, refers to a machine learning model employed to generate new content. The generative model may operate across various domains (e.g., text, images, video, and multi-modal data) to create new content based on learned patterns. The term “machine learning model” refers to any of a broad range of models that can learn to generate automated user input and/or application output by observing properties of past interactions between users and applications. For instance, a machine learning model could be a neural network, a support vector machine, a decision tree, or a clustering algorithm. In some cases, a machine learning model can be trained using labeled training data, a reward function, or other mechanisms. A reward function, as used herein, defines a goal and/or feedback for an agent (e.g., an intelligent agent configured as an entity that perceives its environment and autonomously performs actions to achieve goals) and influences the agent's behavior and learning by assigning numerical scores (e.g., rewards or penalties) to actions and states of the agent. In other cases, a machine learning model can learn by analyzing data without explicit labels or rewards.

One type of generative model 130 is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model 130 is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model 130 can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models 130 can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet (Residual Neural Network), Faster-R-CNN, etc. The term “vision language model” refers to any multi-modal generative model that can generate text describing images or videos, including CLIP, BLIP, Vision-and-Language BERT (Bidirectional Encoder Representations from Transformer), Flamingo, Chameleon, etc.

The term “prompt,” as used herein, refers to a seed provided to a generative model 130 that the generative model 130 uses to generate outputs. A prompt can be provided in various modalities, such as text, an image, audio, video, etc. In some examples, a prompt to a generative model 130 requests output in a particular form (e.g., natural language or an image).

In examples, the object detector 110 provides a prompt to the generative model 130 including the state 210 of the object of interest 105 and an indication to provide the contrast state 220 to the state 210. The object detector 110 further receives, as output from the generative model 130, the contrast state 220 (or a plurality of contrast states).

In examples, the object detector 110 uses the object detection model 120 to generate an embedding of the object of interest 105 (an object of interest (OOI) embedding (e_{OOI}) 225). For instance, when the object of interest 105 has a state 210, the OOI embedding (e_{OOI}) 225 includes an embedding representing the object class 230 and the state 210. Additionally, the object detector 110 uses the object detection model 120 to generate an embedding representing the object class 230 of the object of interest 105 and the contrast state 220 (referred to herein as a contrast-state OOI embedding (e_{cs-OOI}) 250).

According to an aspect, in response to a request 202 for object detection of an object of interest 105 with a state 210, the object detector 110 selects detection embeddings (e_{d}) 175 of detections 125 of a same object class 230 as the object of interest 105 and determines a measure of similarity or dissimilarity (e.g., distances) between the detection embeddings (e_{d}) 175 and the OOI embedding (e_{OOI}) 225 and between the detection embeddings (e_{d}) 175 and the contrast-state OOI embedding (e_{cs-OOI}) 250. Examples of distance metrics used to calculate the measure include cosine similarity, Euclidean distance, Chebyshev distance, and Hamming distance. The object detector 110 further compares the measures. When the distance between the detection embedding (e_{d}) 175 of a detection 125 and the OOI embedding (e_{OOI}) 225 is less (i.e.., shorter) than the distance between the detection embedding (e_{d}) 175 and the contrast-state OOI embedding (e_{cs-OOI}) 250, the object detector 110 classifies the detection 125 as the object class 230 including the state 210. For instance, the object detector 110 classifies the detection 125 as the object of interest 105. Alternatively, when the distance between the detection embedding (e_{d}) 175 of a detection 125 and the contrast-state OOI embedding (e_{cs-OOI}) 250 is shorter than the distance between the detection embedding (e_{d}) 175 of a detection 125 and the OOI embedding (e_{OOI}) 225, the object detector 110 classifies the detection 125 as the object class 230 with the contrast state 220. For instance, the object detector 110 may not classify the detection 125 as the object of interest 105.

The object detector 110 further provides an output 150 in response to a request 202 In some examples, the output 150 includes an indication 204 that a detection 125 is determined as the object of interest 105. In other examples, the output 150 includes an indication 204 that the detection 125 is not determined to be the object of interest 105. The indication 204 may include the description 185 (e.g., a determined class 230, a location (e.g., coordinates) of the detection 125 in the image 102, and/or an identifier of the image 102). In some implementations, the output 150 is provided to an image editor operative to edit the image 102 based on the indication 204. For instance, the image editor may modify the detection 125, such as by replacing the detection 125 with another object 104, masking the detection 125, or otherwise making a change to the image 102 based on the indication 204 of the determination. In some implementations, the image editor is a video editor, where a plurality of images 102 is received (e.g., in a stream or a live stream) and the video editor is able to edit the images 102 in real time or near-real time. In some examples, the image editor is included in the object detector 110. In other examples, the image editor is a separate system.

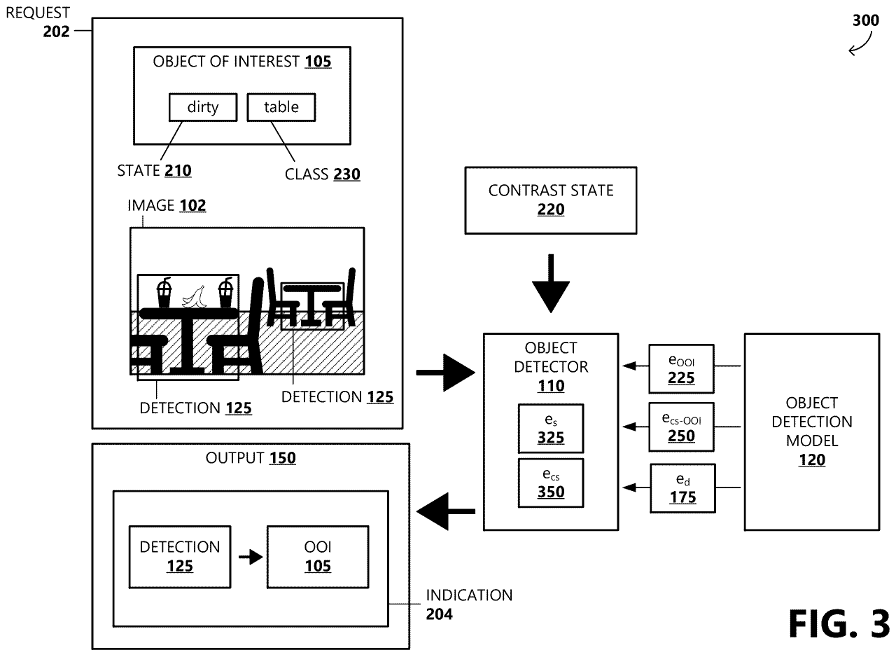

In some implementations, and with reference now to FIG. 3, the object detector 110 generates an embedding of the state 210 (a state embedding(es) 325) and an embedding of the contrast state 220 (a contrast state embedding (e_{cs}) 350) in context of the detections 125. For instance, the object detector 110 compares distances between the detection embedding (e_{d}) 175 for each detection 125 in an image 102 and the state embedding(es) 325 and contrast state embedding (e_{cs}) 350. In examples, the object detector 110 determines differences between the OOI embedding (e_{OOI}) 225 and the contrast-state OOI embedding (e_{cs-OOI}) 250 to determine the state embedding(es) 325 and the contrast state embedding (e_{cs}) 350. Further, the object detector 110 determines distances between the detection embeddings (e_{d}) 175 and the state embedding(es) 325 and between the detection embeddings (e_{d}) 175 and the contrast-state embedding (e_{cs}) 350. The object detector 110 further compares the distances. When the distance between the detection embedding (e_{d}) 175 of a detection 125 and the state embedding(es) 325 is less (e.g., shorter) than the distance between the detection embedding (e_{d}) 175 and the contrast-state embedding (e_{cs}) 350, the object detector 110 classifies the detection 125 as the object class 230 including the state 210. For instance, the object detector 110 classifies the detection 125 as the object of interest 105. Alternatively, when the distance between the detection embedding (e_{d}) 175 of a detection 125 and the contrast-state embedding (e_{cs}) 350 is shorter than the distance between the detection embedding (e_{d}) 175 of a detection 125 and the state embedding(es) 325, the object detector 110 classifies the detection 125 as the object class 230 with the contrast state 220. For instance, the object detector 110 may not classify the detection 125 as the object of interest 105. In some examples, the object detector 110 classifies the detection 125 as the object of interest 105 or as not the object of interest 105 based on a combination of classifications (e.g., a first classification described in FIG. 2 and a second classification described in FIG. 3).

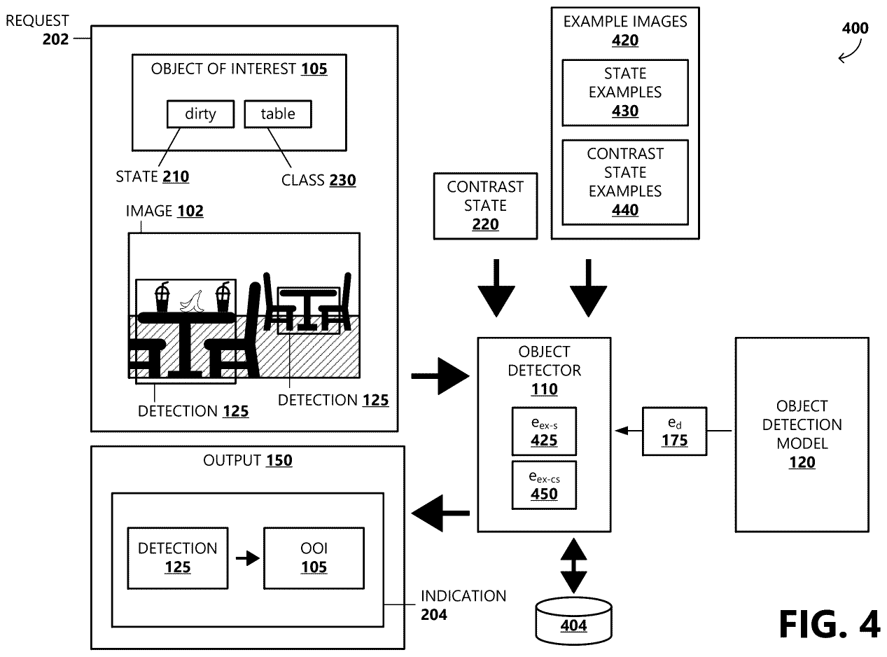

In some implementations, and with reference now to FIG. 4, the object detector 110 receives example images 420 of the object of interest 105 with the state 210 and example images 420 of the object of interest 105 with the contrast state 220. For instance, the object detector 110 provides (e.g., via the user interface 140) an indication for the user to provide (e.g., upload, share, or select) state examples 430 (e.g., example images 420 representing the object class 230 with the state 210) and contrast state examples 440 (e.g., example images 420 representing the object class 230 with the contrast state 220). In response, a user input is received including state examples 430 and contrast state examples 440. In some implementations, the example images 420 include a minimal number (e.g. between 2 and 5) state examples 430 and contrast state examples 440. In examples, the object detector 110 uses the object detection model 120 to determine an embedding for each state example 430 and contrast state example 440. The object detector 110 further averages the determined embeddings of the state examples 430 to generate an average embedding for the state examples 430 (a state example embedding (eₑₓ₋ₛ) 425). Additionally, the object detector 110 averages the determined embeddings of the contrast state examples 430 and generates an average embedding for the contrast state examples 440 (a contrast-state example embedding (e_{ex-cs}) 450). In examples, the object detector 110 stores the state example embedding (eₑₓ₋ₛ) 425 and the contrast-state example embedding (e_{ex-cs}) 450 in a data store 404. Thus, when a detection 125 is made of an object 104 of a same object class 230 as the object of interest 105, the state example embedding (eₑₓ₋ₛ) 425 and the contrast-state example embedding (e_{ex-cs}) 450 are retrieved from the data store 404 and are compared to the detection embedding (e_{d}) 175 associated with the detection 125.

For instance, the object detector 110 compares distances between the detection embedding (e_{d}) 175 and the state example embedding (eₑₓ₋ₛ) 425 and the contrast-state example embedding (e_{ex-cs}) 450. When the distance between the detection embedding (e_{d}) 175 and the state example embedding (eₑₓ₋ₛ) 425 is less (e.g., shorter) than the distance between the detection embedding (e_{d}) 175 and the contrast-state example embedding (e_{ex-cs}) 450, the object detector 110 classifies the detection 125 as the object class 230 including the state 210. For instance, the object detector 110 classifies the detection 125 as the object of interest 105. Alternatively, when the distance between the detection embedding (e_{d}) 175 of a detection 125 and the contrast-state example embedding (e_{ex-cs}) 450 is shorter than the distance between the detection embedding (e_{d}) 175 of a detection 125 and the state example embedding (eₑₓ₋ₛ) 425, the object detector 110 classifies the detection 125 as the object class 230 with the contrast state 220. For instance, the object detector 110 may not classify the detection 125 as the object of interest 105. In some examples, the object detector 110 classifies the detection 125 as the object of interest 105 or not based on a combination of classifications (e.g., the first classification described in FIG. 2, the second classification described in FIG. 3, and/or the third classification described in FIG. 4).

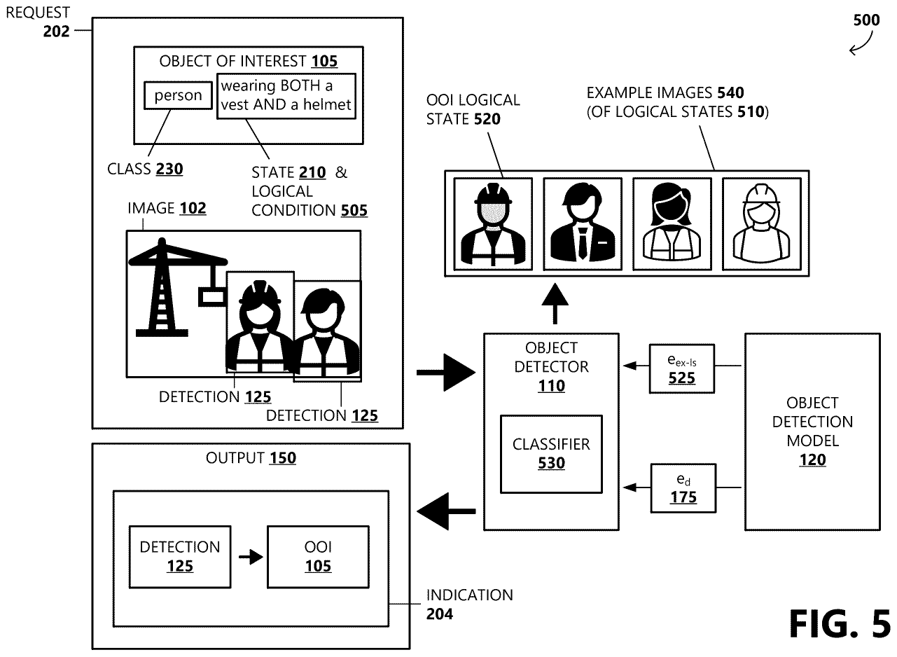

In some implementations, and with reference now to FIG. 5, the object of interest 105 has a state 210 defined by a logical condition 505. For instance, the logical condition 505 is a statement that can be classified as true or false to determine the state 210 of an object 104. For example, “a person wearing both a hat and a vest” is a logical condition 505 that is determined as true if the object 104 (e.g., a person) is detected and a logical state 510 corresponding to the object of interest 105 (referred to as an OOI logical state 520 (e.g., wearing both the hat and the vest)) is determined to be satisfied. Logical states 510 are the possible outcomes that the object 104 can have based on the logical condition 505. For instance, logical states 510 not corresponding to the object of interest 105 are associated with the object of interest 105 with a contrast state 220 (e.g., a person wearing neither a hat nor a vest, a person wearing only a vest, and a person wearing only a hat). Accordingly, the logical condition 505 is determined as false if the object 104 (e.g., a person) is not detected or if the object 104 is detected and the OOI logical state 520 is determined not to be satisfied.

In examples, the object detector 110 receives example images 540 representing each logical state 510 associated with the logical condition 505 of the object of interest 105 (e.g., all logical states 510 of the logical condition 505 of the object of interest 105 are individually and collectively represented in the example images 540). In some examples, the object detector 110 identifies the logical condition 505 and determines the logical states 510 associated with the logical condition 505 (e.g., using a generative model 130). In further examples, the object detector 110 provides (e.g., via the user interface 140) an indication for the user to provide (e.g., upload, share, or select) logical state examples (e.g., example images 540 representing each logical state 510). In response, a user input is received including the logical state examples. In some implementations, the example images 540 include a minimal number (e.g. 5, 10, 20, 25) logical state examples. In examples, the object detector 110 uses the object detection model 120 to determine an embedding for each logical state example (a logical state example embedding (eₑₓ₋ₗₛ) 525) and then train a classifier 530 to differentiate between the logical states 510 based on the logical state example embeddings (eₑₓ₋ₗₛ) 525. Thus, when a detection 125 is made of an object 104 of a same object class 230 as the object of interest 105 (e.g., a person), the object detector 110 uses the classifier 530 to determine whether the logical condition 505 is true or false. For instance, the classifier 530 determines the logical state 510 that best matches the detection 125. When the OOI logical state 520 (e.g., wearing both the hat and the vest) is determined to be satisfied, the logical condition 505 is determined as true. Further, the detection 125 is determined to be the object of interest 105. Alternatively, when another of the logical states 510 (e.g., corresponding to a contrast state 220) is determined to be satisfied, the logical condition 505 is determined as false and, thus, the detection 125 is not the object of interest 105.

In some examples, when a detection 125 is determined to be the object of interest 105, the output 150 includes a notification (e.g., a notification that a person wearing both a hat and a vest is detected). In other examples, when a detection 125 is determined not to be the object of interest 105, the output 150 includes a notification (e.g., a notification that a person not wearing both a hat and a vest is detected). For instance, the system may be used to detect people out of compliance of particular safety protocols, a person wearing only a vest may be detected, and the notification provides an indication 204 that the detected person is determined to not be wearing both a hat and a vest.

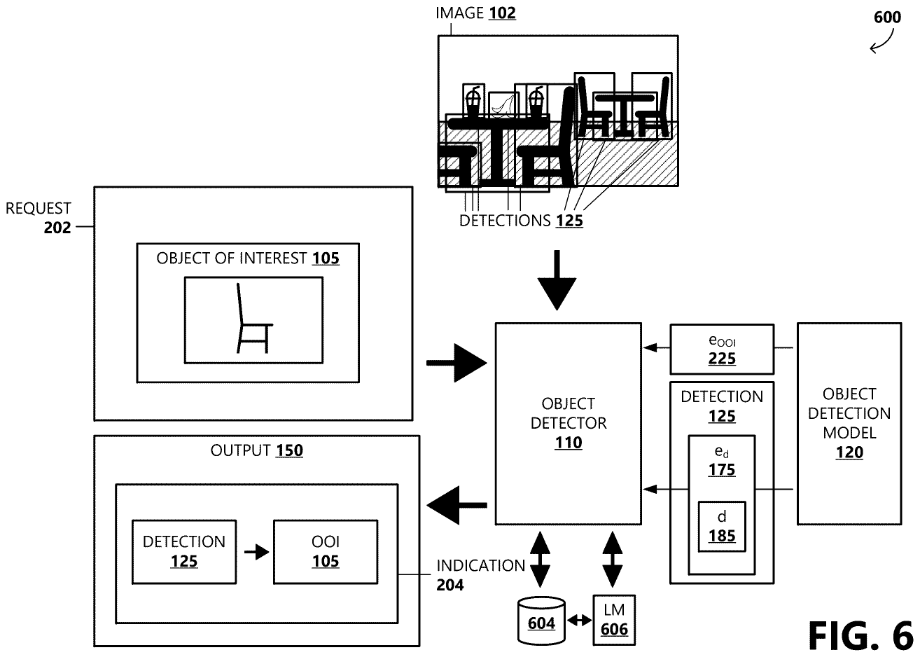

In some implementations, and with reference now to FIG. 6, the object detector 110 receives an image 102 prior to receiving or knowing the object of interest 105. For instance, the object detector 110 uses the object detection model 120 to perform object detection on the image 102 and detect various types of objects 104 in the image 102. The object detector 110 receives one or more detections 125 of objects 104 from the object detection model 120 including a detection embedding (e_{d}) 175 of each detection 125 and a description 185 of the detection 125. In some examples, the description 185 includes a location (e.g., coordinates or a bounding box) of the detection 125 in the image 102 and an identifier of the image 102 (e.g., a video name, a frame number, an image number, and/or an image name). According to an aspect, the object detector 110 stores the detection embedding (e_{d}) 175 of each detection 125 in a data store 604. In some examples, the data store 604 is a vector database. The object detector 110 stores the description 185 in association with the detection embedding (e_{d}) 175.

In some examples, the object detector 110 determines a plurality of detections 125 have similar detection embeddings (e_{d}) 175 (e.g., a similarity measure of the detection embeddings (e_{d}) 175 are within a threshold distance) are identified, the object detector 110 saves the detection embedding (e_{d}) 175 as a key and the description 185 of the plurality of detections 125 as values of the detection embedding (e_{d}) 175. For instance, multiple chairs (e.g., objects 104) detected in an image 102 may be stored in association with one detection embedding (e_{d}) 175. In other examples, the data store 604 is a graph database. For instance, the object detector 110 saves the detection embedding (e_{d}) 175 as a key and the description 185 of the plurality of detections 125 as nodes of the detection embedding (e_{d}) 175 with spatial relations (e.g., edges).

According to examples, after or during processing of one or more images 102, the object detection model 120 receives an object of interest 105 indicating an object 104 that the user wants the object detector 110 to recognize. In some examples, the object of interest 105 is received in the form of text (e.g., free text) or an image that includes an example object representing or otherwise indicating the object of interest 105. The object detector 110 may use natural language processing or a generative model 130 (e.g., a multimodal model) to analyze the text to determine the object of interest 105. According to an example, the object detector 110 determines an OOI embedding (e_{OOI}) 225 for the object of interest 105 and performs one or more queries on the data store 604 for detection embeddings (e_{d}) 175 that match (e.g., within a threshold similarity measure of) the OOI embedding (e_{OOI}) 225. When the object of interest 105 includes multiple objects 104 with relationships (e.g., a person wearing a scarf), the detector 110 may perform a plurality of simple queries and use logic to combine the query results with spatial constraints. The object detector 110 further determines the detections 125 corresponding to the detection embeddings (e_{d}) 175 are the object of interest 105. For instance, the object detector 110 provides an output 150 including an indication 204 that the detections 125 are determined as the object of interest 105. In some examples, the descriptions 185 of the detections 125 are retrieved and provided with the output 150. When the object of interest 105 has a state 210 or a logical condition 505, the object detector 110 may use one or a combination of classifications (e.g., the first classification described in FIG. 2, the second classification described in FIG. 3, the third classification described in FIG. 4, and/or the fourth classification described in FIG. 5) in combination with the fifth classification described in FIG. 6. In some implementations, an artificial intelligent language model 606 is trained based on data stored in the data store 604. For instance, the user interface 140 may include a chat interface that allows the user to have a direct chat with the language model 606 to detect an object of interest 105 in one or more images 102.

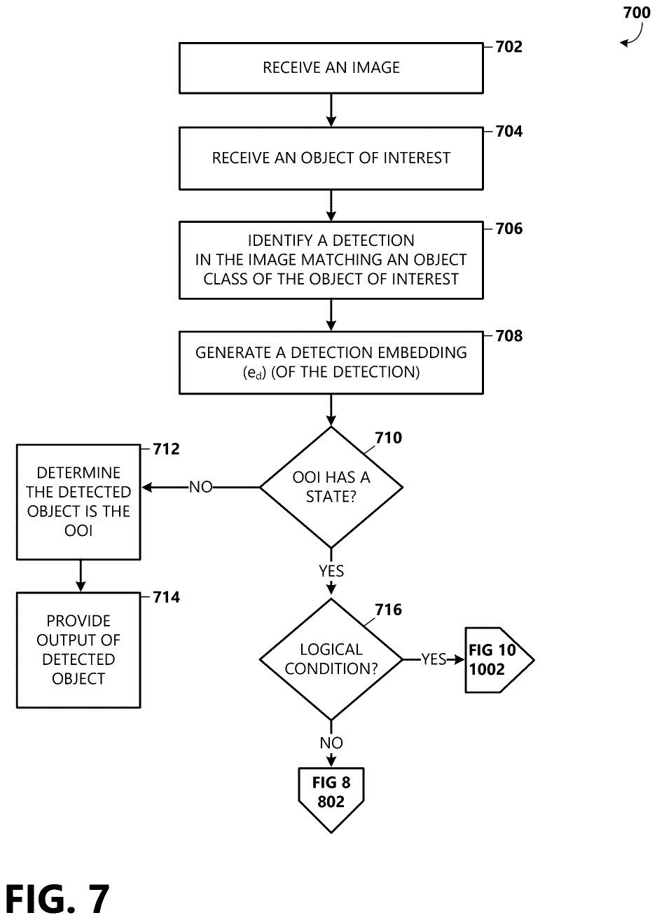

With reference now to FIG. 7, a flow diagram of an example method 700 for providing dynamic customization for object detection is depicted. At operation 702, the object detector 110 receives, as input, image(s) 102 (e.g., from an image store or from a client 108). In some examples, the image(s) 102 are streamed in real-time or near real-time as the image(s) 102 are captured.

At operation 704, the object detector 110 receives an object of interest 105 indicative of an object 104 to detect in the image 102. The object of interest 105 can be provided through various modalities, such as textual descriptions, reference images, or contextual relationships to other objects in the image 102. For example, upon or prior to object detector 110 receiving the images 102, a user or another entity (e.g., an application or a machine learning model) provides a textual description of the object of interest 105 (e.g., “a red car”) to the object detector 110. The user may provide the textual description to the object detector 110 via a user interface 140 associated with the object detector 110, such as graphical user interface of a video capture and/or processing application or service. Alternatively, the entity may provide the textual description to the object detector 110 based on a predefined user setting/preference or learned facts. For instance, the entity may provide a textual description based on a predefined user setting (e.g., object of interest is set to “red cars”) of the object detector 110 or an image processing application or service. In another instance, the entity may provide a textual description based on an identified pattern or relationship within data used to train a machine learning model. For example, the machine learning model determines that, based on previous user signals of a user (e.g., identified via user query history or click log data) a user frequently requests pictures and/or information related to red cars.

In other examples, the object of interest 105 is received in the form of an image (e.g., an image of a red car). The object detector 110 may receive the object of interest 105 in the form of an image, such as a reference image or a sample image containing the target object 104. For instance, an entity may upload or select a picture of a red car to indicate that the object detector 110 should identify a similar object 104 in other images 102 or video frames. Such image-based input can be particularly useful in cases where textual descriptions may be ambiguous or insufficient. In some implementations, feature extraction techniques may be leveraged, such as by using CNNs to identify key attributes of the provided image and use them for object detection.

In other examples, the object of interest 105 is received by relation to another object 104 (e.g., “a red car with a driver wearing a blue shirt”). For instance, instead of receiving an indication of a single target object 104 (e.g., “a red car”), an entity may specify “a red car with a driver wearing a blue shirt.” In this case, the object detector 110 may be instructed to detect not only the presence of a red car, but also a contextual relationship between the car and the driver.

In other examples, the object of interest 105 is received in the form of spoken command (e.g., “detect the red car”), etc. The client 108 may include a microphone and receive the spoken command. An automatic speech recognition (ASR) system integrated in or in communication with the object detector 110 may process the spoken command to determine the target object 104. Such implementations are particularly beneficial for hands-free interactions, such as in smart surveillance systems, automotive applications, or accessibility-focused applications designed for users with disabilities.

In some implementations, operation 704 is performed prior to operation 702. For instance, the object detector 110 may receive an indication of the target object 104 to detect before obtaining or analyzing the images 102.

At operation 706, the object detector 110 uses an object detection model 120 to process the image 102 to identify objects 104. In examples, the object detection model 120 generates detection embeddings (e_{d}) 175 of detections 125 identified in the image 102. For instance, the object detector 110 receives, from the object detection model 120, detections 125, their associated detection embeddings (e_{d}) 175, and descriptions 185 (e.g., object class 230 and location). Further, the object detector 110 determines the detections 125 that match (e.g., within a threshold similarity measure) the object class 230 of the object of interest 105.

At decision operation 710, the object detector 110 determines whether the object of interest 105 includes a state 210 (e.g., an object 104 and an adjective, phrase, or other indication of a feature of the object 104). When a state 210 is not identified, the method 700 proceeds to operation 712, where the detections 125 are determined as the object of interest 105. At operation 714, the object detector 110 provides an output 150 including an indication 204 of the detections 125.

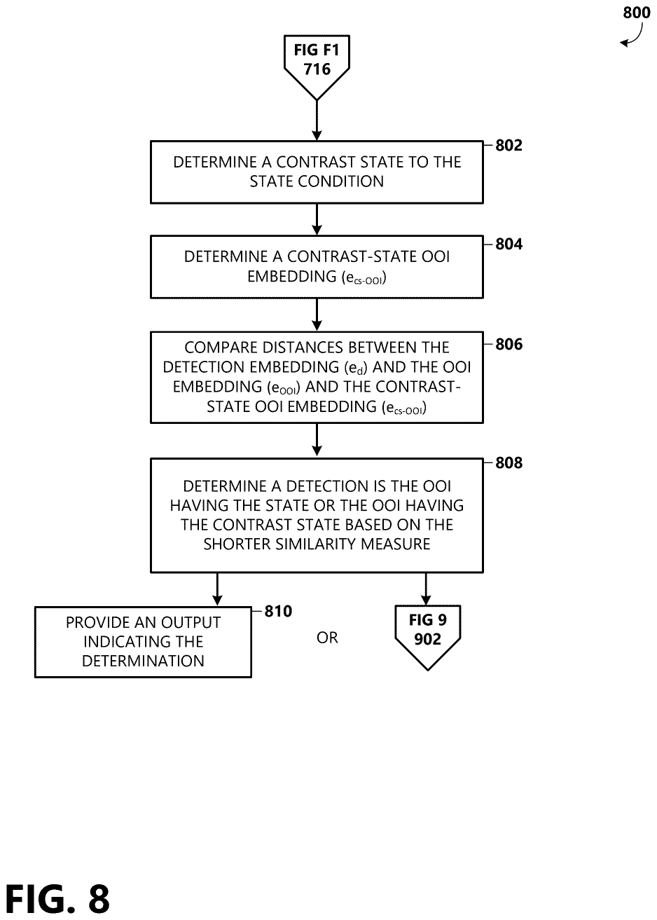

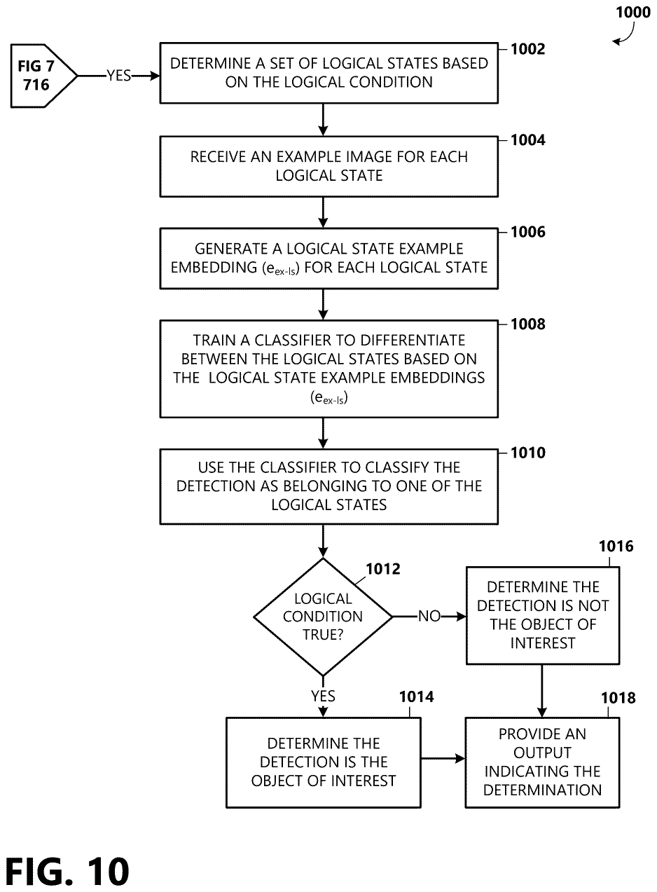

Alternatively, when the object detector 110 determines the object of interest 105 includes a state 210 at decision operation 710, the method 700 proceeds to operation 716, where a determination is made as to whether the state 210 is defined by a logical condition 505 (e.g., that can be classified as true or false to determine the state 210 of the detection 125). When the state 210 is not defined by a logical condition 505, the method 700 proceeds to operation 802 of method 800 depicted in FIG. 8. Alternatively, when the state 210 is defined by a logical condition 505, the method 700 proceeds to operation 1002 of method 1000 depicted in FIG. 10.

With reference now to FIG. 8, a flow diagram of another example method 800 for providing dynamic customization for object detection (e.g., when a state 210 of the object of interest 105 is not defined by a logical condition 505) is depicted. At operation 802, the object detector 110 determines a contrast state 220 to the state 210. In some implementations, the contrast state 220 is received in response to prompting the user for user input including the contrast state 220. The user input may be received in the form of text or an image of an example object representing or otherwise indicating the object of interest 105 with the contrast state 220 to the state 210 that the user wants the object detector 110 to detect. In other implementations, the contrast state 220 is received in response to the object detector 110 requesting the contrast state 220 from a generative model 130. In some examples, a plurality of contrast states 220 to the state are received or otherwise determined.

At operation 804, the object detector 110 uses the object detection model 120 to determine a contrast-state OOI embedding (e_{cs-OOI}) 250 representing the object class 230 of the object of interest 105 and each contrast state 220.

At operation 806, the object detector 110 compares the detection embeddings (e_{d}) 175 and the OOI embedding (e_{OOI}) 225 (e.g., representing the object class 230 and the state 210) and the detection embeddings (e_{d}) 175 and the contrast-state OOI embeddings (e_{cs-OOI}) 250 based on a similarity threshold measure.

At operation 808, the object detector 110 determines whether the detections 125 are the object of interest 105 including the state 210 based on a closer measure of similarity between the detection embeddings (e_{d}) 175 and the OOI embeddings (e_{OOI}) 225 or whether the detections 125 are the object of interest 105 with a contrast state 220 or based on a closer measure of similarity between the detection embeddings (e_{d}) 175 and the contrast-state OOI embeddings (e_{cs-OOI}) 250. When a determination is made that a detection 125 is the object of interest 105 including the state 210, the detection 125 is classified as the object of interest 105.

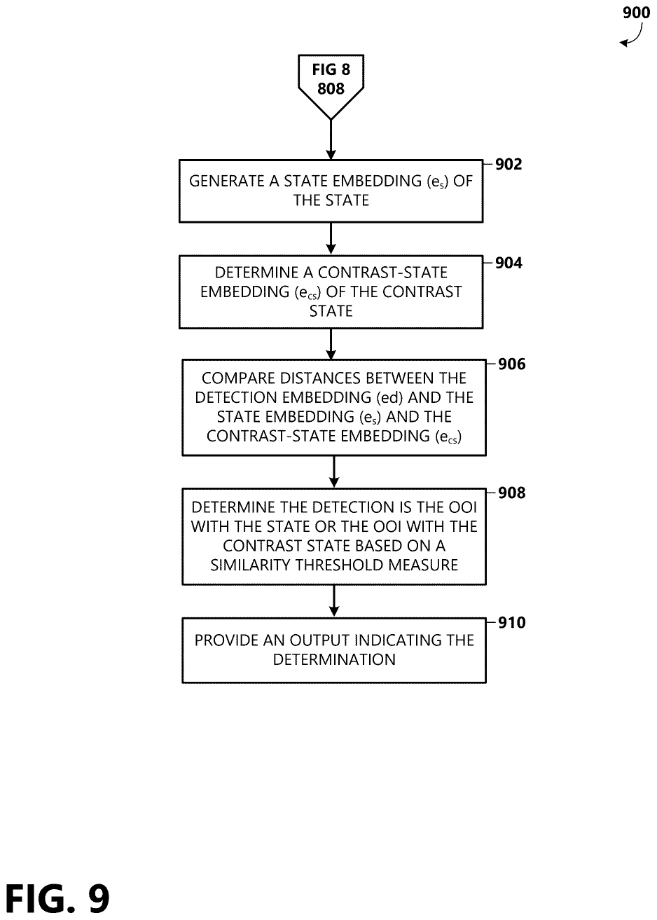

At operation 810, the object detector 110 provides an output 150 including an indication 204 of the detections 125 determined/classified as the object of interest 105. Or, in some implementations, the method 800 proceeds to operation 902 of method 900 depicted in FIG. 9 for another classification.

With reference now to FIG. 9, a flow diagram of another example method 900 for providing dynamic customization for object detection is depicted. At operation 902, the object detector 110 determines a first difference between the OOI embedding (e_{OOI}) 225 and the contrast-state OOI embedding (e_{cs-OOI}) 250 (e.g., using mathematical operations on vectors) to determine a state embedding(es) 325) of the state 210. At operation 904, the object detector 110 determines a second difference between the OOI embedding (e_{OOI}) 225 and the contrast-state OOI embedding (e_{cs-OOI}) 250 (e.g., using embeddings arithmetic) to determine a contrast state embedding (e_{cs}) 350) of the contrast state 220.

At operation 906, the object detector 110 determines distances between the detection embeddings (e_{d}) 175 for each detection 125 in an image 102 and the state embedding(es) 325 and between the detection embeddings (e_{d}) 175 and the contrast-state embedding (e_{cs}) 350. Further, the object detector 110 compares the distances.

At operation 908, the object detector 110 determines whether the detections 125 are the object of interest 105 including the state 210 based on a closer measure of similarity between the detection embeddings (e_{d}) 175 and the state embedding(es) 325 or whether the detections 125 are the object of interest 105 with a contrast state 220 based on a closer measure of similarity between the detection embeddings (e_{d}) 175 and the contrast-state embeddings (e_{cs}) 350. When a determination is made that a detection 125 is the object of interest 105 including the state 210, the detection 125 is classified as the object of interest 105.

At operation 910, the object detector 110 provides an output 150 including an indication 204 of the detections 125 determined/classified as the object of interest 105.

With reference now to FIG. 10, a flow diagram of another example method 1000 for providing dynamic customization for object detection (e.g., when a state 210 of the object of interest 105 is defined by a logical condition 505) is depicted. At operation 1002, the object detector 110 determines a set of logical states 510 (e.g., possible outcomes that the object 104 can have) based on the logical condition 505. The logical states 510 includes at least one OOI logical state 520 corresponding to the object of interest 105 (e.g., when satisfied, causes the logical condition 505 to be true) and at least one other logical state 510 that, when satisfied, causes the logical condition 505 to be false. In some examples, the object detector 110 prompts the user for the set of logical states 510 and receives the logical states 510 in response. In other examples, the object detector 110 requests the set of logical states 510 from a generative model 130.

At operation 1004, the object detector 110 receives example images 540 representing each logical state 510. In some examples, the object detector 110 prompts the user for the example images 540 and receives the example images 540 in response. In further examples, a minimal number of example images 540 are received.

At operation 1006, the object detector 110 uses the object detection model 120 to determine a logical state example embedding (eₑₓ₋ₗₛ) 525 representing each logical state example in the example images 540. Further, at operation 1008, a classifier 530 is trained to differentiate between the logical states 510 based on the logical state example embeddings (eₑₓ₋ₗₛ) 525.

At operation 1010, the object detector 110 uses the classifier 530 to determine the logical state 510 that best matches the detection 125 (e.g., based on a similarity threshold measure).

At decision operation 1012, a determination is made as to whether the logical condition 505 is true or false. For instance, the object detector 110 determines whether the OOI logical state 520 is satisfied (e.g., is a match to the detection 125). When the OOI logical state 520 is satisfied, the method 1000 proceeds to operation 1014, where logical condition 505 is determined to be true and the detection 125 is determined to be the object of interest 105. Alternatively, when another of the logical states 510 is determined to be satisfied (e.g., and the OOI logical state 520 is not satisfied), the logical condition 505 is determined as false. Thus, at operation 1016, the detection 125 is determined not to be the object of interest 105.

At operation 1018, the object detector 110 provides an output 150 indicating the determination made at operation 1014 or 1016.

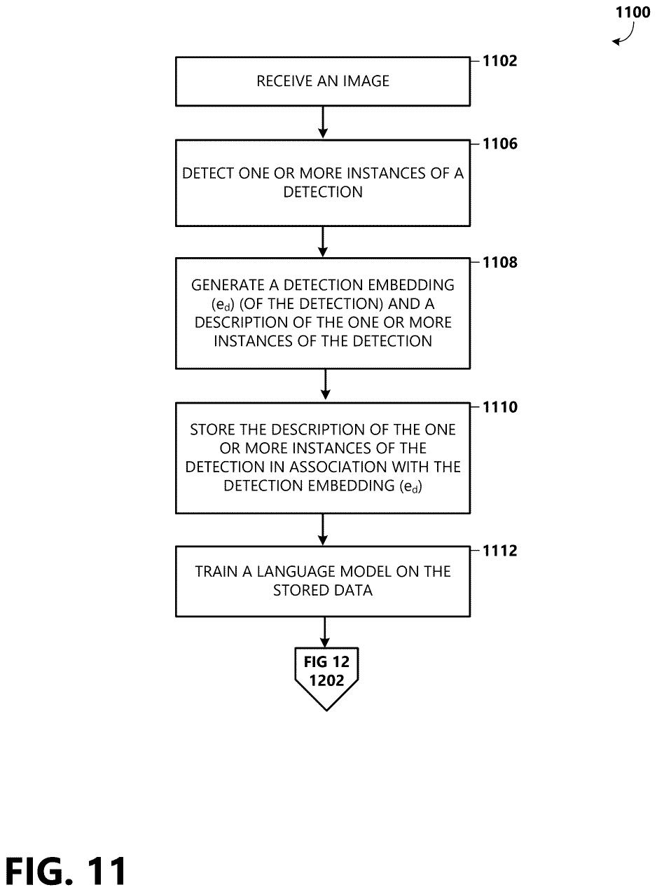

With reference now to FIG. 11, a flow diagram of another example method 1100 for providing dynamic customization for object detection is depicted. At operation 1102, the object detector 110 receives one or more images 102. For instance, the one or more images 102 may be received from an image store, from a client 108, streamed in real-time or near real-time as the image(s) 102 are captured, etc.

At operation 1106, the object detector 110 uses the object detection model 120 to detect one or more instances of a detection 125 in the images 102. For instance, the object detection model 120 processes the images 102 prior to receiving the object of interest 105 indicating an object 104 that the user wants the object detector 110 to detect. In examples, the object detector 110 detects various types of objects 104 in the image 102 and, at operation 1108, the object detector 110 receives one or more detections 125 of objects 104 from the object detection model 120 including a detection embedding (e_{d}) 175 of each detection 125 and a description 185 of the detection 125. In some examples, the description 185 includes a location of the detection 125 in the image 102 and an identifier of the image 102 (e.g., a video name, a frame number, an image number, and/or an image name).

At operation 1110, the object detector 110 stores the detection embedding (e_{d}) 175 of each detection 125 in a data store 604, such as a vector database or a graph database. In examples, the object detector 110 stores the description 185 of each instance of the detection 125 in association with the detection embedding (e_{d}) 175. In some examples, the object detector 110 saves the detection embedding (e_{d}) 175 as a key and the description 185 of the plurality of detections 125 as values of the detection embedding (e_{d}) 175. In other examples, the object detector 110 saves the detection embedding (e_{d}) 175 as a key and the description 185 of the plurality of detections 125 as nodes of the detection embedding (e_{d}) 175 with spatial relations (e.g., edges).

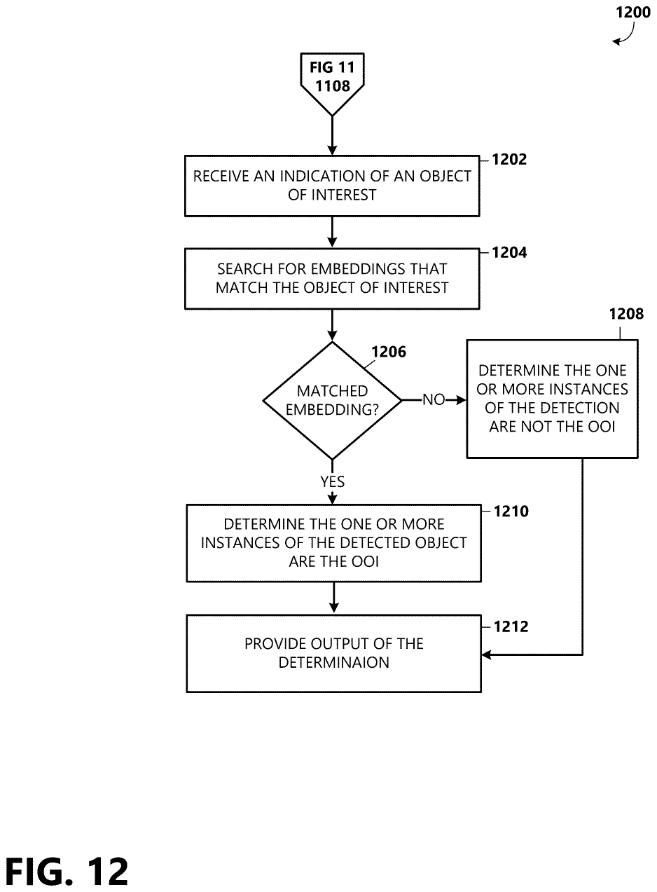

In examples, a language model 606 is trained to work on the latent space of the detection embeddings (e_{d}) 175 and associated descriptions 185 determined by the object detection model 120 and stored in the data store 604. In some examples, the user interface 140 provided by the object detector 110 includes a chat interface that allows the user to have a direct chat with the language model 606 to provide an object of interest 105 and to receive an output 150 in response. Optionally, at operation 1112, the language model 606 is trained based on data stored in the data store 604. In some implementations, the method 1100 proceeds to operation 1202 of method 1200 depicted in FIG. 12.

With reference now to FIG. 12, a flow diagram of another example method 1200 for providing dynamic customization for object detection is depicted. At operation 1202, the object detector 110 receives an object of interest 105. In some examples, the object of interest 105 is received in the form of text (e.g., free text) or an image that includes an example object representing or otherwise indicating the object of interest 105. The object detector 110 may use natural language processing, a generative model 130, or a multimodal model to analyze the text or image to determine the object of interest 105.

At operation 1204, the object detector 110 determines an OOI embedding (e_{OOI}) 225 for the object of interest 105 and performs one or more queries on the data store 604 for detection embeddings (e_{d}) 175 that match (e.g., within a threshold similarity measure of) the OOI embedding (e_{OOI}) 225. When the object of interest 105 includes multiple objects 104 with relationships (e.g., a person wearing a scarf), the detector 110 may perform a plurality of simple queries and use logic to combine the query results with spatial constraints to identify matching detection embeddings (e_{d}) 175.

At decision operation 1206, the object detector 110 makes a determination as to whether a detection embedding (e_{d}) 175 matches the OOI embedding (e_{OOI}) 225 within a threshold similarity measure. When the detection embedding (e_{d}) 175 does not match the OOI embedding (e_{OOI}) 225, the method 1200 proceeds to operation 1208, where the object detector 110 determines the one or more instances of the detection 125 are not the object of interest 105. Alternatively, when the detection embedding (e_{d}) 175 matches the OOI embedding (e_{OOI}) 225 within a threshold similarity measure, the method 1200 proceeds to operation 1210, where the object detector 110 determines the one or more instances of the detection 125 are the object of interest 105.

At operation 1212, the object detector 110 provides an output 150 including an indication 204 of the determination (e.g., that the detections 125 are determined to be the object of interest 105 or not to be the object of interest 105)

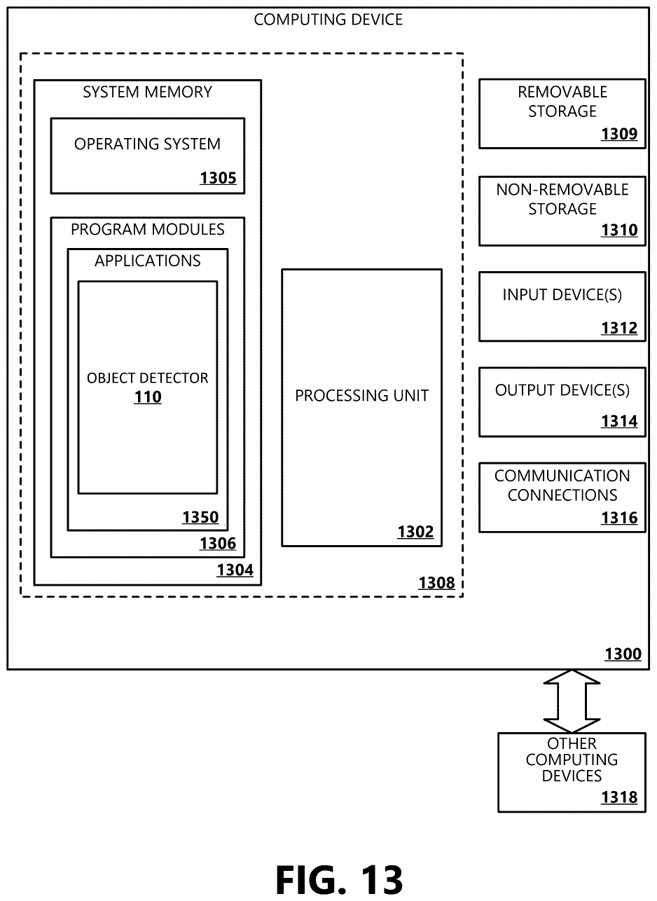

FIG. 13 and the associated description provide a discussion of a variety of operating environments in which examples of the invention may be practiced. However, the devices and systems illustrated and discussed with respect to FIG. 13 is for purposes of example and illustration and is not limiting of a vast number of computing device configurations that may be utilized for practicing aspects of the invention, described herein. FIG. 13 is a block diagram illustrating physical components (i.e., hardware) of a computing device 1300 with which examples of the present disclosure may be practiced. In a basic configuration, the computing device 1300 may include at least one processing unit and a system memory 1304. in examples, the processing unit(s) (e.g., processors) are referred to as a processing system 1302. Depending on the configuration and type of computing device, the system memory 1304 may comprise volatile storage (e.g., random access memory), non-volatile storage (e.g., read-only memory), flash memory, or any combination of such memories. The system memory 1304 may include an operating system 1305 and one or more program modules 1306 suitable for running software applications 1350 (e.g., regression detector 110).

The operating system 1305, for example, may be suitable for controlling the operation of the computing device 1300. Furthermore, aspects of the invention may be practiced in conjunction with a graphics library, other operating systems, or any other application program and is not limited to any particular application or system. This basic configuration is illustrated in FIG. 13 by those components within a dashed line 1308. The computing device 1300 may have additional features or functionality. For example, the computing device 1300 may also include additional data storage devices (removable and/or non-removable) such as, for example, magnetic disks, optical disks, or tape. Such additional storage is illustrated in FIG. 13 by a removable storage device 1309 and a non-removable storage device 1310.

As stated above, a number of program modules and data files may be stored in the system memory 1304. While executing on the processing system 1302, the program modules 1306 may perform processes including one or more of the operations of the methods 700, 800, 900, 1000, 1100, and/or 1200 illustrated in FIGS. 7, 8, 9, 10, 11, and/or 12. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 1300 on the single integrated circuit (chip). Examples of the present disclosure may also be practiced using other technologies capable of performing logical operations such as, for example, AND, OR, and NOT, including mechanical, optical, fluidic, and quantum technologies.

The computing device 1300 may also have one or more input device(s) 1312 such as a keyboard, a mouse, a pen, a sound input device, a touch input device, etc. The output device(s) 1314 such as a display, speakers, a printer, etc. may also be included. The aforementioned devices are examples and others may be used. The computing device 1300 may include one or more communication connections 1316 allowing communications with other computing devices 1318. Examples of suitable communication connections 1316 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (i.e., memory storage). Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. Any such computer storage media may be part of the computing device 1300. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method, comprising:
receiving a first image;
receiving an object of interest having an object class and a state;
identifying a detection in the first image based on the object class;
generating a first representation of the detection;
determining a contrast state to the state;
generating a second representation of the object class and the state;
generating a third representation of the object class and the contrast state;
comparing a first similarity measure between the first representation and the second representation to a second similarity measure between the first representation and the third representation;
generating a first classification of the detection based on whether the first similarity measure is less than the second similarity measure or whether the second similarity measure is less than the first similarity measure; and
providing an output of the first classification.

2. The method of claim 1, wherein generating
the first classification comprises classifying the detection as the object of interest when the first similarity measure is less than the second similarity measure.

3. The method of claim 2, further comprising modifying the detection in the first image.

4. The method of claim 1, further comprising:
generating a fourth representation representing the state by determining a first difference between the second representation and the third representation;
generating a fifth embedding representing the contrast state by determining a second difference between the second representation and the third representation;
comparing: a third similarity measure between the first representation and the fourth representation to a fourth similarity measure between the first representation and the fifth representation;
generating a second classification classifying the detection based on whether the third similarity measure is less than the fourth similarity measure or whether the fourth similarity measure is less than the third similarity measure; and
providing an output of the second classification.

5. The method of claim 4, wherein generating the second classification comprises classifying the detection as the object of interest when the third similarity measure is less than the fourth similarity measure.

6. The method of claim 1, wherein determining the contrast state to the state comprises:
providing a request to a language model for the contrast state to the state; and
receiving a result from the language model including the contrast state; or
providing, via a user interface, an indication to provide the contrast state to the state; and
receiving a user input via the user interface including the contrast state.

7. The method of claim 6, wherein:
the user input includes free text; and
generating the third representation comprises generating a representation of the free text.

8. The method of claim 6, wherein:
the user input includes a second image including an example of the object class and the contrast state; and
generating the third representation comprises generating a representation of the example of the object class and the contrast state.

9. The method of claim 8, wherein:
the second image comprises a plurality of second images including a plurality of examples of the object class and the contrast state; and
generating the third embedding comprises determining an average embedding of the plurality of examples of the object class with the contrast state.

10. The method of claim 6, wherein:
the indication to provide the contrast state to the state includes an indication to provide a second image including an example of the object class and the state;
receiving the user input further comprises receiving the second image; and
generating the second representation comprises generating the second representation based on the example of the object class and the state included in the second image.

11. The method of claim 1, wherein the contrast state comprises a plurality of contrast states.

12. The method of claim 1, further comprising:
determining the state includes a logical condition;
determining a set of logical states based on the logical condition, wherein a first logical state of the set of logical states corresponds to the state and one or more second logical states of the set of logical states correspond to the contrast state;
receiving a second image for each logical state in the set of logical states, where each second image includes an example of the object class and the logical state;
generating, for each logical state in the set of logical states, a fourth representation of each example of the object class and the logical state;
comparing a third similarity measure between the first representation and each fourth representation;
generating a second classification of the detection based on the third similarity measure; and
providing an output of the second classification.

13. The method of claim 12, wherein generating the second classification comprises classifying the detection as the object of interest when the third similarity measure between the first representation and the fourth representation of the first logical state is a shortest of the third similarity measures.

14. The method of claim 12, further comprising:
training a classifier to differentiate between the logical states based on the fourth representation of each example; and
using the classifier to generate the second classification.

15. The method of claim 1, wherein comparing the first similarity measure and the second similarity measure comprises:
applying a first threshold to the first similarity measure; and
applying a second threshold to the second similarity measure.

16. A system, comprising:
a processing system; and
memory storing instructions that, when executed, cause the system to perform operations comprising:
receiving a first image;
receiving an object of interest having an object class and a state;
identifying a detection in the first image based on the object class;
generating a first embedding of the detection;
determining a contrast state to the state;
generating a second embedding of the object class and the state;
generating a third embedding of the object class and the contrast state;
comparing a first distance between the first embedding and the second embedding to a second distance between the first embedding and the third embedding;
generating a first classification of the detection based on whether the first distance is less than the second distance or whether the second distance is less than the first distance; and
providing an output of the first classification.

17. The system of claim 16, the operations further comprising:
generating a fourth embedding representing the state by determining a first difference between the second embedding and the third embedding;
generating a fifth embedding representing the contrast state by determining a second difference between the second embedding and the third embedding;
comparing: a third distance between the first embedding and the fourth embedding to a fourth distance between the first embedding and the fifth embedding;
generating a second classification, classifying the detection based on whether the third distance is less than the fourth distance or whether the fourth distance is less than the third distance; and
providing an output of the second classification.

18. The system of claim 16, wherein determining the contrast state to the state comprises:
providing a request to a language model for the contrast state to the state; and
receiving a result from the language model including the contrast state; or
providing, via a user interface, an indication to provide the contrast state to the state; and
receiving a user input via the user interface including the contrast state.

19. The system of claim 16, the operations further comprising:
determining the state includes a logical condition;
determining a set of logical states based on the logical condition, wherein a first logical state of the set corresponds to the state and one or more second logical states of the set correspond to the contrast state;
receiving a second image for each logical state in the set, where each second image includes an example of the object class and the logical state;
generating, for each logical state, a fourth embedding of each example of the object class and the logical state;
comparing a third distance between the first embedding and each fourth embedding;
generating a second classification of the detection based on the third distance; and
providing an output of the second classification.

20. A computer readable medium storing instructions that, when executed by a computer, cause the computer to:
receive a first image;
receive an object of interest having an object class and a state;
determining whether the state includes a logical condition;
when the state does not include the logical condition:
identify a detection in the first image based on the object class;
generate a first embedding of the detection;
determine a contrast state to the state;
generate a second embedding of the object class and the state;
generate a third embedding of the object class and the contrast state;
compare a first distance between the first embedding and the second embedding to a second distance between the first embedding and the third embedding; and
generate a first classification of the detection based on whether the first distance is less than the second distance or whether the second distance is less than the first distance; and
provide an output of the first classification; and
when the state includes the logical condition:
determine a set of logical states based on the logical condition, wherein a first logical state of the set corresponds to the state and one or more second logical states of the set correspond to the contrast state;
receive a second image for each logical state in the set, where each second image includes an example of the object class and the logical state;
generate, for each logical state, a fourth embedding of each example of the object class and the logical state;
compare a third distance between the first embedding and each fourth embedding;
generate a second classification of the detection based on the third distance; and
provide an output of the second classification.
